(19) United States
(12) Patent Application Publication
(10) Pub. No.: US 2008/0114877 A1
(43) Pub. Date: May 15, 2008

(54) SERIAL DATA TRANSMISSION METHOD AND SERIAL DATA TRANSMISSION APPARATUS

(75) Inventors: Yoichiro MORI, Osaka (JP); Yasuhiro UNO, Kyoto (JP); Yukinobu HAMAJIMA, Osaka (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Osaka (JP)

(21) Appl. No.: 11/938,382

(22) Filed: Nov. 12, 2007

(30) Foreign Application Priority Data
Nov. 13, 2006 (JP) 2006-306756

(51) Int. Cl. G06F 15/16

(52) U.S. Cl. 709/224

(57) ABSTRACT

Data transmission and reception is effected via a data transmission line between a master device, which is capable of controlling data transfer, and a slave device in synchronism with a clock signal transmitted from the master device to the slave device via a clock transmission line. A signal indicative of the presence or absence of changes in the state of the slave device is sent to a third line connecting the master device to the slave device. The master device effects transmission for the purpose of acquiring data concerning state changes on the slave device side when the signal of the third line indicates that a state change has taken place on the slave device side. The transmission load can be reduced by effecting transmission used by the master device to check data representing the state of the slave device only when necessary.

### BACKGROUND OF THE INVENTION

1. Field of the Invention

The present invention relates to serial data transmissions between a semiconductor device effecting control (master device) and a controlled semiconductor device (slave device).

2. Description of Related Art

Conventional methods used for data transmission via a three-line bus connection include a digital transmission method disclosed in JP 2002-539646A. FIG. 6 illustrates this conventional three-line digital data transmission method. Hereinbelow, the operation of the data transmission system described in JP 2002-539646A is explained with reference to FIG. 6.

In FIG. 6, a three-line bus connection system is formed between one master device 101, which is a digital signal processor, and two slave devices 102, which are peripheral devices. Clock line 103 usually transmits a system clock signal generated by the master device 101. Continuous digital data, which is written by the two slave devices 102, is transmitted to the master device 101 via a data line 104. In this case, data output units ASD, which output data, are provided in the slave devices 102, and a data input unit ESD is provided in the master device 101.

Moreover, two-valued authorization signals, each represented in the binary system, are sent from the master device 101 via an authorization line (WS) 105, which is called a “word-select line (Word Select Leitung)”, thereby determining which one of the two slave devices 102 writes data intended for the master device 101 to the common data line 104, or when is the timing.

In addition, the master device 101 has an encoder (ENC), which is connected to the output of the authorization line (WS) 105, and the slave devices 102 respectively have decoders (DEC), which are connected to the input of the authorization line (WS) 105. Data signals superimposed on specific time periods of the authorization signals are transmitted from the encoder of the master device 101 to the slave devices 102 and decoded by the respective decoders.

For the master device 101 to purposively, as well as selectively, initiate calls to one or more slave devices 102 provided, the data signals superimposed on the authorization signals have, if necessary, the call addresses of the corresponding slave devices 102.

By operating as described above, two-way transmission, on the one hand, from the slave devices 102 to the master device 101 via the data line 104 and, on the other hand, from the master device 101 to the slave devices 102 via the authorization line WS 105, can be effected between the slave devices 102 and master device 101.

In a data transmission system such as the one described above, both when transmission is effected from the slave devices 102 to the master device 101 via the data line 104 and when transmission is effected from the master device 101 to the slave devices 102 via the authorization line (WS) 105, the master device 101 always effects control over the timing of transmission using the authorization line (WS) 105.

In addition, when checking data representative of the state of the slave devices 102, the master device 101 needs to effect data transmission at arbitrary times regardless of the presence or absence of changes in the state of the slave devices 102. Accordingly, this increases the transmission load of the master device 101 used for monitoring the state of the respective slave devices 102 when a large number of slave devices 102 was connected to a single master device 101.

### SUMMARY OF THE INVENTION

The present invention eliminates the above-described prior-art problems and it is an object of the invention to provide a serial data transmission method capable of reducing the transmission load by effecting transmission performed by the master device to check data representing the state of the slave device(s) only when it is necessary.

In order to attain the above-described object, the serial data transmission method of the present invention effects data transmission and reception via a data transmission line between a master device, which is capable of controlling data transfer, and a slave device in synchronism with a clock signal transmitted from the master device to the slave device via a clock transmission line. A signal indicative of the presence or absence of changes in the state of the slave device is sent to a third line connecting the master device to the slave device, and the master device effects transmission for the purpose of acquiring data concerning state changes on the slave device side when the signal of the third line indicates that a state change has taken place on the slave device side.

The serial data transmission apparatus of the present invention comprises a master device capable of controlling data transfer, a slave device effecting transmission and reception of data to and from the master device, a clock transmission line used to transmit a clock signal from the master device to the slave device, and a data transmission line used to transmit data between the master device and the slave device and effects serial data transmission between the master device and slave device in synchronism with the clock signal, with the master device configured to effect transmission for the purpose of acquiring data concerning state changes on the slave device side. Furthermore, it comprises a third line supplying a signal indicative of the presence or absence of state changes on the slave device side to the master device, and the master device effects transmission for the purpose of acquiring data concerning state changes on the slave device side when the signal of the third line indicates that a state change has taken place on the slave device side.

### BRIEF DESCRIPTION OF THE DRAWINGS

FIG. 1 is a block diagram showing a serial data transmission apparatus used in a serial data transmission method according to Embodiment 1 of the present invention.

FIG. 2 is a timing chart of the outputs of the same serial data transmission method.

FIG. 3 is a block diagram showing a serial data transmission apparatus used in a serial data transmission method according to Embodiment 2 of the present invention.

FIG. 4 is a timing chart of the outputs of the same serial data transmission method.

FIG. 5 is a block diagram showing another exemplary configuration of the serial data transmission apparatus.

FIG. 6 is a block diagram showing a serial data transmission apparatus used in the conventional three-line digital data transmission method.

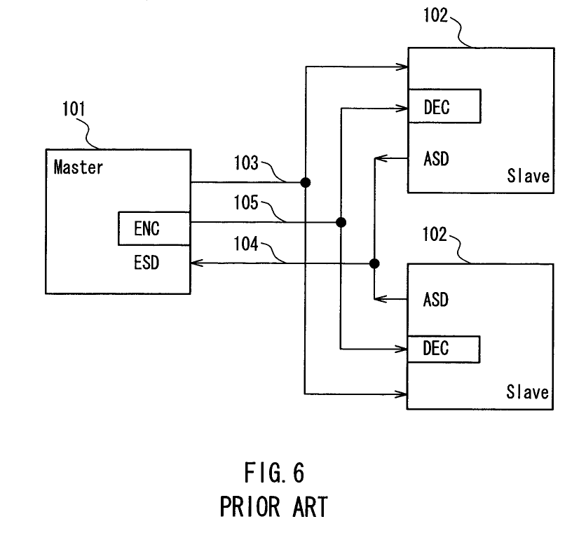

### DETAILED DESCRIPTION OF THE INVENTION

In accordance with the serial data transmission method of the present invention having the above-described configuration, the master device is informed of state changes on the slave device side with the help of the third line, thereby allowing the master device to check data representing the state of the slave device only when it is necessary and permitting a reduction in the transmission load.

Based on the above-described configuration, the present invention can assume the following various embodiments.

In the serial data transmission method of the present invention, the slave device preferably detects the state on the slave device side and outputs status data, and the third line is controlled in such a manner that its state alters before changes and after changes in the status data.

Moreover, control preferably is effected in such a manner that, if the state of the third line changes, the state of the third line goes back to the state existing prior to the change when the master device checks the status data.

Moreover, after the state of the third line changes, control preferably is effected in such a manner that even if the status data subsequently changes again and goes back to the initial state, and if such operations are repeated, the state of the third line does not go back to the state existing prior to the change until the master device checks the status data. This provides for reliable recognition of the state of the slave device when a state change takes place.

In the serial data transmission apparatus of the present invention, the slave device has a status output unit detecting the state on the slave device side and outputting status data and a comparison unit detecting changes in the status data output by the status output unit, and the state of the third line preferably is changed in response to changes in the status data detected by the comparison unit.

Moreover, the slave device preferably has a read detection unit detecting that the master device has checked the status data and supplying read detection data, and the third line, if its state has changed, goes back to the state existing prior to the change in response to the read detection data from the read detection unit.

Moreover, the slave device has an output holding unit holding changes in the status data detected by the comparison unit, and the third line, if its state has changed, does not go back to the state existing prior to the change until the read detection data is output from the read detection unit even if the detection result of the comparison unit changes again and goes back to the initial state, as well as if such operations are repeated.

Embodiments of the serial data transmission method and apparatus of the present invention will be described below with reference to drawings.

### EMBODIMENT 1

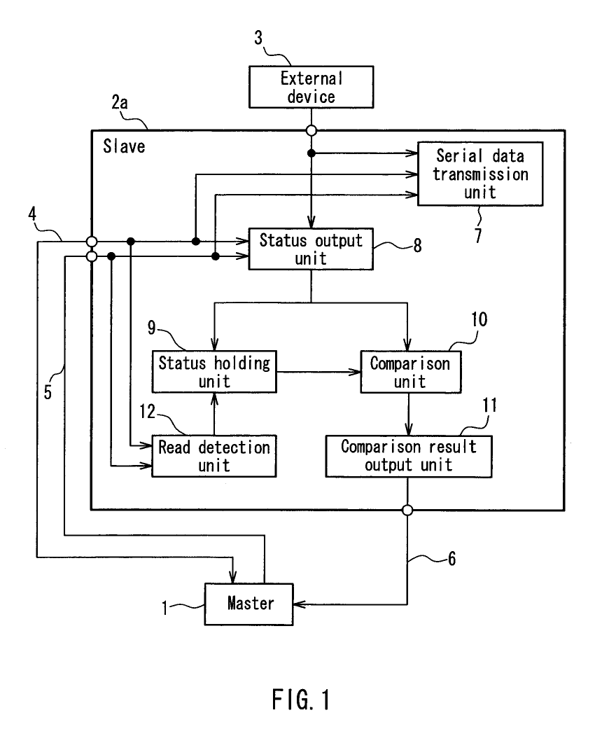

FIG. 1 a block diagram showing a serial data transmission apparatus used in a serial data transmission method according to Embodiment 1 of the present invention.

In FIG. 1, reference numeral 1 denotes a master device effecting control over data transfer, and 2a denotes a slave device addressed by the master device 1 and subject to data transfer control by the master device 1. The slave device 2a can be connected to an external device 3, and can adopt a condition in which the external device 3 is connected, as shown in FIG. 1, as well as a condition in which it is not connected.

The master device 1 and slave device 2a are interconnected by a serial data line (hereinafter referred to as “SDA” for short) 4, which is a data transmission line, a serial clock line (“SCL”) 5, which is a clock transmission line, and a third line 6. The SDA 4 is a line used to transmit data between the master device 1 and slave device 2a, the SCL 5 is a line used to transmit a clock signal from the master device 1 to the slave device 2a, and the third line 6 is a line used to transmit a signal indicative of the presence or absence of changes in the state of the slave device 2a.

A serial data transmission unit 7, which is provided in the slave device 2a, is connected to the master device 1 via the SDA 4 and SCL 5. The serial data transmission unit 7 can be connected to the external device 3 and effects serial data transmission with the master device 1.

Furthermore, a status output unit 8, which is provided in the slave device 2a in the present embodiment, is connected to the master device 1 via the SDA 4 and SCL 5 and can be connected to the external device 3. The status output unit 8, whose output alters depending on the presence or absence of connection to the external device 3, outputs status data. A status holding unit 9 holds the data of the status output unit 8. A comparison unit 10 compares the data of the status holding unit 9 with the data of the status output unit 8 at certain times. A comparison result output unit 11 controls the output in accordance with the comparison results of the comparison unit 10.

Furthermore, a read detection unit 12, which is provided in the slave device 2a, is connected to the master device 1 via the SDA 4 and SCL 5. The read detection unit 12 detects the timing (hereinafter referred to as the “master read” timing) at which the master device 1 checks the state of the slave device 2a via the SDA 4, and supplies the detection results to the status holding unit 9.

Based on the above configuration, the master device 1 effects transmission for the purpose of acquiring data concerning the presence or absence of connection of the external device 3 to the slave device 2a, that is, changes in the state of the slave device 2a.

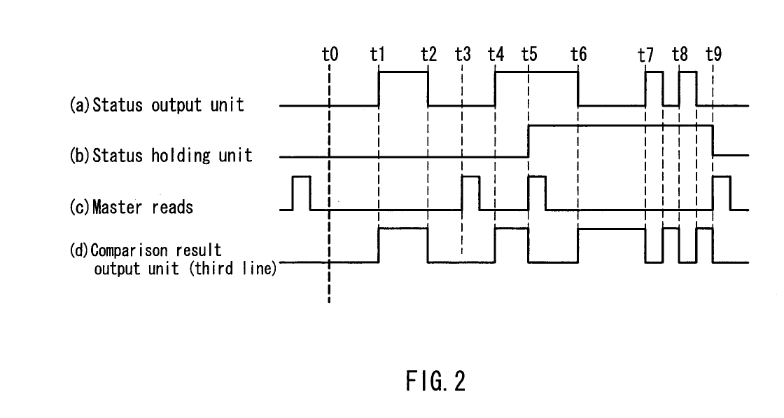

The operation of the serial data transmission method configured in the above-described manner is explained below with reference to the timing chart of FIG. 2.

In FIG. 2, (a) shows the waveform of the data of the status output unit 8, whose output alters between “high” and “low” depending on the state of presence or absence of connection to the external device 3. In addition, (b) shows the waveform of the data of the status holding unit 9. Also, the waveform of (c) shows the master read timing, where the timing of master reads is indicated by a high level. Additionally, (d) shows the waveform of the data of the third line 6 (which is the same as the output of the comparison result output unit 11). Master reads are performed only when the data of the third line 6 is high. However, the timing of the master reads is generated in an order corresponding to the state of transmission with other slave devices.

The waveform of the status holding unit 9 of (b) maintains the high or low state of the status output unit 8 of (a) obtained when a master read takes place, i.e. when the waveform of (c) goes high. Moreover, when the comparison unit 10 detects that the data of the status holding unit 9 and the data of the status output unit 8 are different, the data of the comparison result output unit 11 goes high and, consequently, the data of the third line 6 of (d) goes high. When the data of the status holding unit 9 and the data of the status output unit 8 are the same, the data of the third line 6 of (d) goes low.

The operation described by the exemplary waveforms of FIG. 2 is as follows. First of all, the waveform of (c) shows that a master read took place at a certain time prior to moment t0, which is indicated by a short dashes line. At such time, the read detection unit 12 detects the master read and actuates the status holding unit 9, causing it to hold the state of the status output unit 8, and, since the output of the status output unit 8 of (a) is low, at moment t0, the status holding unit 9 is low. Furthermore, since the data of both the status output unit 8 and status holding unit 9 are low, i.e. the same, the output of the comparison unit 10 is low and the data of the third line 6 (comparison result output unit 11) of (d) is low.

Subsequently, at moment t1, the connection state of the external device 3 changes, and the status output unit 8 goes high. At such time, a difference of “high” versus “low” is created between the data of the status output unit 8 and status holding unit 9, and, as a result, a high level is output by the comparison unit 10 and the data of the third line 6 of (d) goes from low to high. Subsequently, at moment t2, the status output unit 8 goes low and assumes the same state as the status holding unit 9, as a result of which the third line 6 goes from high to low. Thus, even if the data of the third line 6 goes high, sometimes it may end up going low again before a master read is performed. This is due to the fact that the timing of the master reads is generated in an order corresponding to the state of transmission with other slave devices and the master reads sometimes are performed too late.

Subsequently, at moment t3, a master read takes place, and, since the status output unit 8 is low, the status holding unit 9 remains low. After that, at moment t4, the third line 6 goes from low to high in the same manner as at moment t1. Subsequently, at moment t5, a master read takes place, and, since the status output unit 8 is high, the status holding unit 9 of (b) goes high. As a result, since the data of the status output unit 8 and the data of the status holding unit 9 are both high, the third line 6 of (d) goes from high to low.

Subsequently, at moment t6, the status output unit 8 goes low while the data of the status holding unit 9 is high, which creates a difference, and, as a result, the third line 6 goes from low to high. Subsequently, as the state of the status output unit 8 changes in succession, as it does at moment t7 and moment t8, the data of the status output unit 8 and status holding unit 9 are compared by the comparison unit 10 and, when there is a difference between the data, the third line 6 goes high, and when there is no difference, low. Then, at moment t9, a master read takes place, and, because the output of the status output unit 8 is low, the status holding unit 9 goes low, resulting in the same data, and the output of the third line 6 goes from high to low.

As described above, in accordance with the present embodiment, once the master device 1 checks the state of the slave device 2a, the state of the third line 6 changes again if there is a difference between the data of the status output unit 8 and status holding unit 9 and, therefore, it is sufficient for the master device 1 to check the state of the slave device 2a at such times only. In other words, if there are no changes in the state of the third line 6, the master device 1 does not have to check the state of the slave device 2a. Therefore, the frequency of transmission can be reduced and the transmission load of the entire transmission channel can be reduced.

### EMBODIMENT 2

In Embodiment 1, the data of the status output unit 8 and status holding unit 9 simply are compared and, if there is a difference, the state of the third line 6 is changed, such that when the data of the status output unit 8 goes back to the initial state, the state of the third line 6 goes back to the initial state as well.

In contrast, in the configuration of Embodiment 2, as described below, the state of the third line 6 is not changed until a master read takes place.

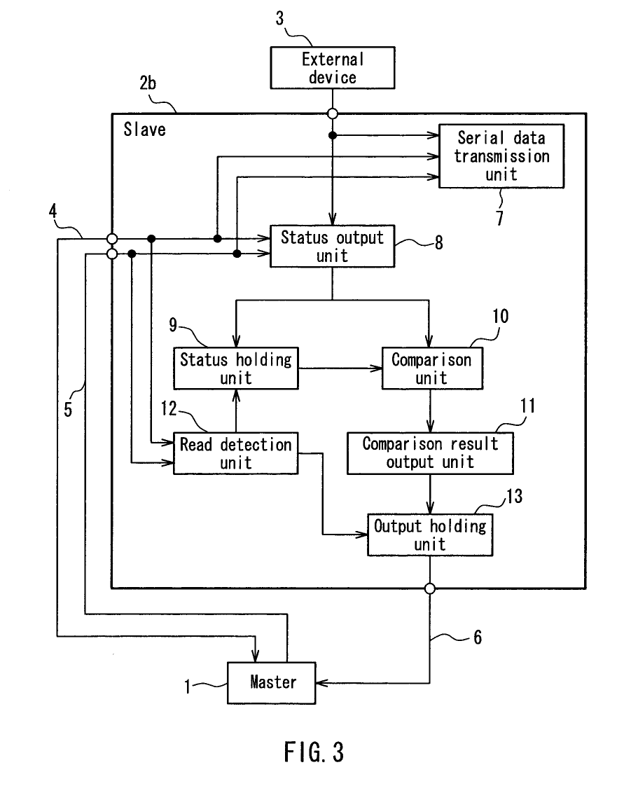

FIG. 3 is a block diagram showing a serial data transmission apparatus used in a serial data transmission method according to Embodiment 2 of the present invention. In FIG. 3, elements identical to the elements of the apparatus of Embodiment 1 illustrated in FIG. 1 are assigned the same reference numerals, and their explanation is not repeated.

The difference in the configuration of the present embodiment from the configuration of Embodiment 1 is the provision of an output holding unit 13 holding the state of the comparison result output unit 11. The output of the read detection unit 12 is supplied to the output holding unit 13 and control based on the master read timing is carried out as described below.

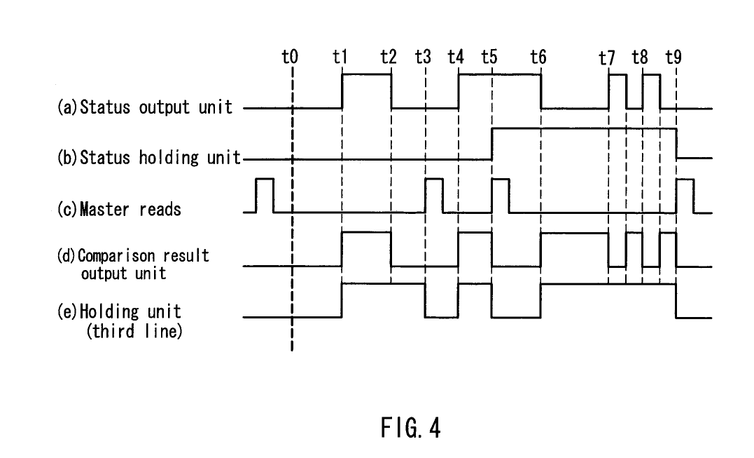

The operation of the serial data transmission method configured as described above is explained below with reference to the timing chart of FIG. 4.

In FIG. 4, the waveforms of (a) through (d) are the same as the waveforms of FIG. 2 related to Embodiment 1. Namely, (a) shows the waveform of the data of the status output unit 8, (b) the waveform of the data of the status holding unit 9, (c) the master read waveform, and (d) the waveform of the output of the comparison result output unit 11. Also, (e), which is an additional waveform used in the present embodiment, shows the waveform of the output holding unit 13, i.e. the data of the third line 6. The output of the output holding unit 13 does not go low until a master read takes place. Accordingly, the state of the third line 6 held in the output holding unit 13 does not go low until a master read takes place.

Changes in the waveforms illustrated in FIG. 4 are the same as in case of FIG. 2 up to moment t6. In other words, it shows that the master read of (c) took place at a certain point in time prior to moment t0, which is indicated by a short dashes line. At such time, the read detection unit 12 detects the master read and actuates the status holding unit 9, causing it to hold the state of the status output unit 8, but because the output of the status output unit 8 of (a) is low, at moment t0, the status holding unit 9 is low. Since the data of both the status output unit 8 and status holding unit 9 is low, i.e. the same, the output of the comparison unit 10 is low, and the data of the comparison result output unit 11 of (d) is low. In addition, the output holding unit 13 operates in response to the output of the read detection unit 12, but since the data of the comparison result output unit 11 is low, the data of the third line 6 (output holding unit 13) is low.

Subsequently, at moment t1, the connection state of the external device 3 changes, and the status output unit 8 goes high. At such time, a difference of “high” versus “low” is created between the data of the status output unit 8 and status holding unit 9, and, as a result, a high level is output by the comparison unit 10 and the data of the comparison result output unit 11 of (d) goes from low to high. As a result, the data of the third line 6 (output holding unit 13) of (e) also goes from low to high.

Subsequently, at moment t2, the status output unit 8 goes low and assumes the same state as the status holding unit 9, but because the output holding unit 13 does not go low until a master read takes place, the state of the third line 6 held by the output holding unit 13 remains high. This is the difference from Embodiment 1. After that, at moment t3, a master read takes place, as a result of which the third line 6 goes from high to low.

Subsequently, at moment t4, the third line 6 goes from low to high in the same manner as at moment t1. After that, at moment t5, a master read takes place, and because the status output unit 8 is high, the status holding unit 9 of (b) goes high. Accordingly, since the data of the status output unit 8 and the data of the status holding unit 9 are both high, the data of the comparison result output unit 11 goes low. Moreover, because of the master read, the third line 6 also goes from high to low.

Subsequently, at moment t6, the output of the status output unit 8 goes low while the data of the status holding unit 9 is high, which creates a difference, and, as a result, the data of the comparison result output unit 11 goes high and the third line 6 also goes from low to high. After that, as the state of the status output unit 8 changes in succession, as it does at moment t7 and moment t8, the state of the third line 6 is held in the output holding unit 13 and does not go low until a master read takes place, such that the state of the third line 6 remains high. Subsequently, at moment t9, a master read takes place, and, since the status output unit 8 is low, the status holding unit 9 goes low, producing in the same data, as a result of which the third line 6 goes from high to low.

As described above, in accordance with the present embodiment, once the master device 1 checks the state of the slave device 2b, the state of the third line 6 changes again if there is a difference between the data of the status output unit 8 and status holding unit 9 and, therefore, it is sufficient for the master device 1 to check the state of the slave device 2b at such times only. In other words, if there are no changes in the state of the slave device 2b, the master device 1 does not have to check the state of the slave device 2b. Therefore, the frequency of transmission can be reduced and the transmission load of the entire transmission channel can be reduced.

Moreover, since the state of the third line 6 does not go back to the state existing prior to the change until data representative of the state of the slave device 2b is checked by the master device 1, the state of the slave device 2b can be checked reliably if a change of state takes place.

It should be noted that while in Embodiments 1 and 2 above a case where changes in the state of the slave devices 2a, 2b lie in the presence or absence of connection to an external device was used as an example, the present invention is also applicable to cases in which the master device 1 performs operations aimed at checking for other changes in the state of the slave devices 2a, 2b.

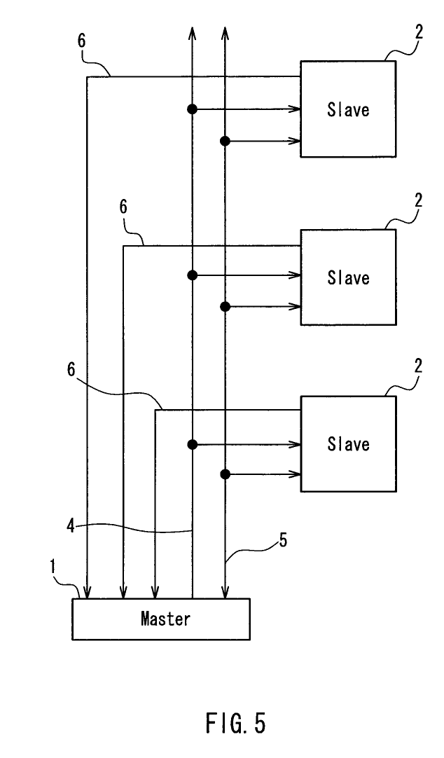

Moreover, while the configurations illustrated in FIG. 1 and FIG. 3 show a state, in which a single slave device 2a, or 2b, is connected to the master device 1, the present invention is also applicable to systems, in which multiple slave devices 2 are connected to the master device 1, as shown in FIG. 5, and is particularly effective in such systems.

In other words, when many slave devices 2 were connected to the master device 1, as shown in FIG. 5, the transmission load generated when the state of the respective slave devices 2 was checked at arbitrary times was substantial, but, in accordance with the present embodiment, the transmission load can be reduced because it is sufficient to communicate data only with the slave device 2 for which the data that represents the state of the slave device 2 exhibits changes.

Because the serial data transmission method of the present invention, as described above, effects data transmission only when necessary and permits a reduction in the transmission load, it is useful for serial data transmissions between ICs, LSI and other semiconductor devices.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A serial data transmission method effecting data transmission and reception via a data transmission line between a master device, which is capable of controlling data transfer, and a slave device in synchronism with a clock signal transmitted from the master device to the slave device via a clock transmission line,
wherein a signal indicative of the presence or absence of changes in the state of the slave device is sent to a third line connecting the master device to the slave device, and
the master device effects transmission for the purpose of acquiring data concerning state changes on the slave device side when the signal of the third line indicates that a state change has taken place on the slave device side.

2. The serial data transmission method according to claim 1,
wherein the slave device detects the state on the slave device side and outputs status data, and
the third line is controlled in such a manner that its state alters before changes and after changes in the status data.

3. The serial data transmission method according to claim 2,
wherein control is effected in such a manner that, if the state of the third line has changed, the state of the third line goes back to the state existing prior to the change when the master device checks the status data.

4. The serial data transmission method according to claim 3,
wherein after the state of the third line changes, control is effected in such a manner that even if the status data subsequently changes again and goes back to the initial state, as well as if such operations are repeated, the state of the third line does not go back to the state existing prior to the change until the master device checks the status data.

5. A serial data transmission apparatus comprising:
a master device capable of controlling data transfer,
a slave device effecting transmission and reception of data to and from the master device,
a clock transmission line used to transmit a clock signal from the master device to the slave device, and
a data transmission line used to transmit data between the master device and the slave device,
the apparatus effecting serial data transmission between the master device and slave device in synchronism with the clock signal, with the master device being configured to effect transmission for the purpose of acquiring data concerning state changes on the slave device side,
wherein the apparatus comprises a third line supplying a signal indicative of the presence or absence of state changes on the slave device side to the master device, and
the master device effects transmission for the purpose of acquiring data concerning state changes on the slave device side when the signal of the third line indicates that a state change has taken place on the slave device side.

6. The serial data transmission apparatus according to claim 5,
wherein the slave device has a status output unit detecting the state on the slave device side and outputting status data and a comparison unit detecting changes in the status data output by the status output unit, and
the state of the third line is changed in response to changes in the status data detected by the comparison unit.

7. The serial data transmission apparatus according to claim 6,
wherein the slave device has a read detection unit detecting that the master device has checked the status data and supplying read detection data, and
the third line, if its state has changed, goes back to the state existing prior to the change in response to the read detection data from the read detection unit.

8. The serial data transmission apparatus according to claim 7,
wherein the slave device has an output holding unit holding changes in the status data detected by the comparison unit, and
the third line, if its state has changed, does not go back to the state existing prior to the change until the read detection data is output from the read detection unit even if the detection result of the comparison unit changes again and goes back to the initial state, as well as if such operations are repeated.
